(19) United States
(12) Patent Application Publication
(10) Pub. No.: US 2023/0064095 A1
(43) Pub. Date: Mar. 2, 2023

(54) INLINE SAFETY VALVE

(71) Applicant: PETROTECHNOLOGIES, INC., Broussard, LA (US)

(72) Inventor: David Levy, Broussard, LA (US)

(21) Appl. No.: 17/464,231

(22) Filed: Sep. 1, 2021

(51) Int. Cl. F16K 15/06

(52) U.S. Cl. CPC F16K 15/063; F16K 15/064; E21B 34/14

(57) ABSTRACT

The present disclosure generally relates to an inline safety valve providing for robust handling of very high pressures due to the fact that only static seals are utilized, and the seals are placed outside the flow path of fluid. This design allows for release of potential energy in a controlled fashion with an adjustable bias or back pressure. The inline safety valve can have a valve body, a poppet, a piston disposed between a portion of the poppet and the valve body, a plurality of holes disposed on the poppet allowing a fluid to flow therethrough, a bias on the piston forcing the piston toward the poppet, and a static seal disposed between the poppet and the valve body, wherein the static seal is not within a flow path of the fluid. In embodiments, fluid flow through the plurality of holes can cause a displacement of the piston.

### FIELD

The present disclosure generally relates to an inline safety valve.

### BACKGROUND

Check valves with a back pressure retention feature are utilized in various industrial applications to prevent backflow and uncontrolled flow in the forward direction. Check valves mechanically allow fluid to flow, or pressure to act in only one direction. Back pressure retention (BPR) requires an amount of forward pressure before flow commences. Check valves are designed for a variety of operating conditions or fluid parameters.

Several issues exist with check valves that are currently used. Especially in deep sea operations, check valves are subjected to extremely high pressures and extreme temperatures.

Current designs which make use of dynamic sealing surfaces, or seals within the flow path of fluid can result in seal failure and undesired leaks. Further, wear on the seal surface can reduce sealing efficacy over time. Current valve designs incorporate the seal into the flow path of fluid, thereby subjecting the seal to damage. As high pressure opens the valve, large amounts of energy are released and subsequently absorbed by the seal.

In vertical oil and gas well applications, a vacuum is created if the inline safety valve leaks. This can allow the fluid pressure to drop to the vapor pressure of the liquid, which in turn can cause solids to precipitate and potentially clog the tube and prevent injection of antifreeze. Losing the ability to inject antifreeze can cause production fluid to freeze upon commencing production. Further, a failure of the check valve in this instance can cause an uncontrolled dump of antifreeze fluid into the production stream.

It is desirable, therefore, to have a safety valve which cures the above deficiencies.

The present disclosure provides an inline safety valve capable of handling extremely high pressures with sealing surfaces removed from the fluid flow path, thereby resulting in an extremely reliable and robust, bubble tight valve.

### BRIEF DESCRIPTION OF THE DRAWINGS

The detailed description will be better understood in conjunction with the accompanying drawings as follows:

FIG. 1A shows a prior art inline check valve.

FIG. 1B shows a cut view of prior art inline check valve.

FIG. 2A depicts an embodiment of the presently disclosed inline safety valve.

FIG. 2B depicts a cut view of an embodiment of the presently disclosed inline safety valve in a closed position.

FIG. 2C depicts a cut view of an embodiment of the presently disclosed inline safety valve in an open position.

FIG. 2D depicts a closeup view of the cut view of an embodiment of the presently disclosed inline safety valve in an open position of FIG. 2C.

The embodiments of the present disclosure are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to an inline safety valve. The present disclosure allows for robust handling of very high pressures due to the fact that only static seals are utilized and the seals are placed outside the flow path of fluid. This novel design provides significant advantages over prior art allowing for release of potential energy in a controlled fashion with an adjustable bias or back pressure.

The inline safety valve can have a valve body, a poppet disposed within the valve body, a piston disposed within the valve body, wherein a portion of the piston is disposed between a portion of the poppet and the valve body, a plurality of holes disposed on the poppet allowing a fluid to flow therethrough, a bias on the piston, wherein the bias forces the piston toward the poppet, and a static seal disposed between the poppet and the valve body, wherein the static seal is not within a flow path of the fluid. In embodiments, fluid flow through the plurality of holes can cause a displacement of the piston.

The valve body can comprise any suitable material as chosen by persons having ordinary skill in the art. Based upon type of fluid, pressure, and operating environment, a large range of suitable materials can be utilized.

The poppet can be disposed within the valve body. In embodiments, the poppet can allow fluid to enter within the poppet. In embodiments, the poppet can be bubble tight.

Bubble tight is an industry term known to persons having ordinary skill in the art meaning that no bubbles are observed leaking past the seat (sealing surface) of the valve.

The poppet can have a plurality of holes which can allow a fluid to flow therethrough. A static seal, i.e., a seal between two non-moving parts, can be disposed between the poppet and the valve body. The static seal can be removed from the flow path of the fluid.

The static seal can be any suitable seal chosen by persons having ordinary skill in the art, including but not limited to o-rings and gaskets. Seal materials can be chosen based upon the specific application. In embodiments, the static seal can hold the poppet stationary with respect to the valve body.

The piston can be biased to form a fluid tight seal against the poppet. The bias can be any suitable bias as known to persons having ordinary skill in the art. Various springs, or materials such as washers, which can act as springs can be utilized as the bias. In embodiments, a screw can be tightened or loosened to adjust the bias on the piston.

In embodiments, the piston can at least partially overlap the poppet. In embodiments, a portion of the piston can be located between the poppet and the valve body.

Fluid can be allowed to flow through the plurality of holes and apply pressure to the piston. When enough pressure to overcome the bias is applied, the piston can be displaced, thereby allowing fluid to flow through the valve in a single direction. When the bias overcomes fluid pressure, the piston can seal against the poppet, thereby preventing fluid backflow in the opposite direction.

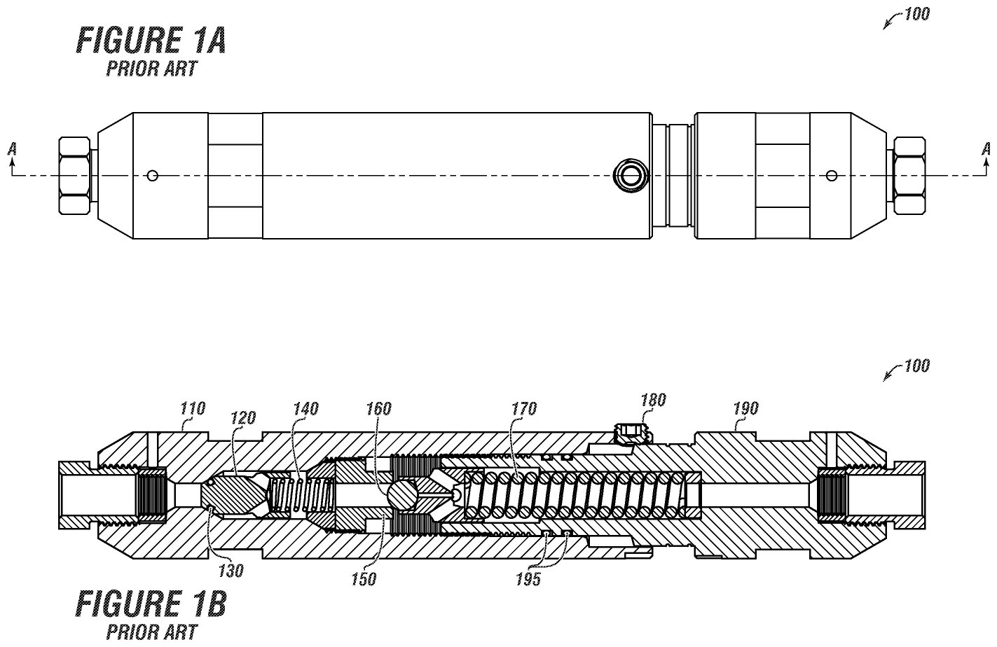

Turning now to the Figures, FIGS. 1A and 1B show a prior art check valve.

The check valve 100 has a valve body 110 which houses the poppet 120. The poppet 120 has a first seal 130. A first spring 140 biases the poppet 120 closed against the valve body 110. As fluid pressure forces the poppet 120 to overcome first spring 140, fluid can flow around the poppet. Note that first seal 130 is directly within the flow path of the fluid.

The prior art check valve 100 can also have a seat 150 with a ball 160 which is biased against the seat by a second spring 170. The prior art check valve 100 can also have an end cap 190 with a second seal 195 which seals against the valve body. A set screw 180 can be utilized to hold end cap 190 in place and thereby allow adjustments to the bias applied by second spring 170.

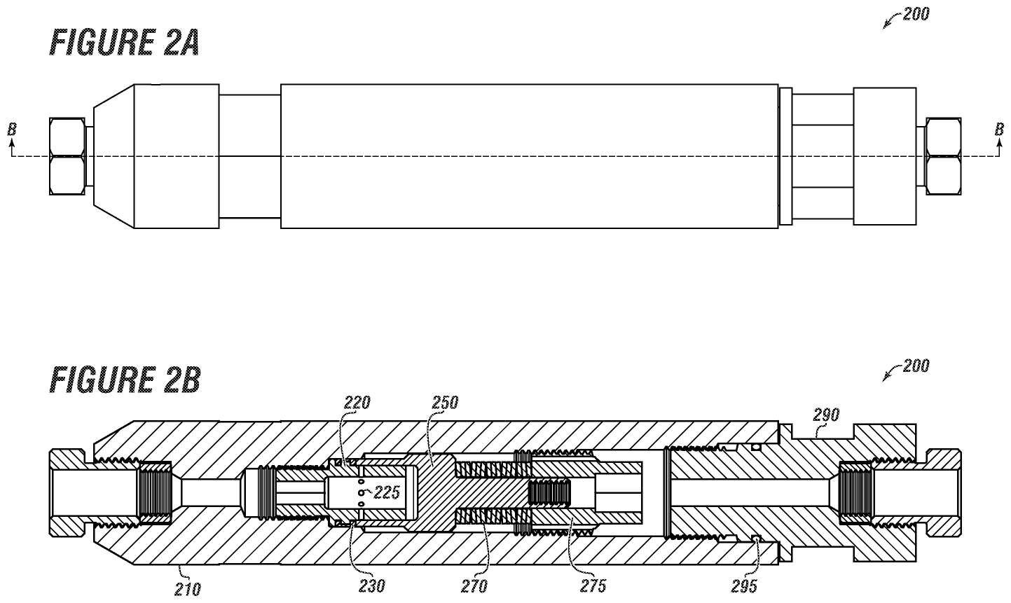

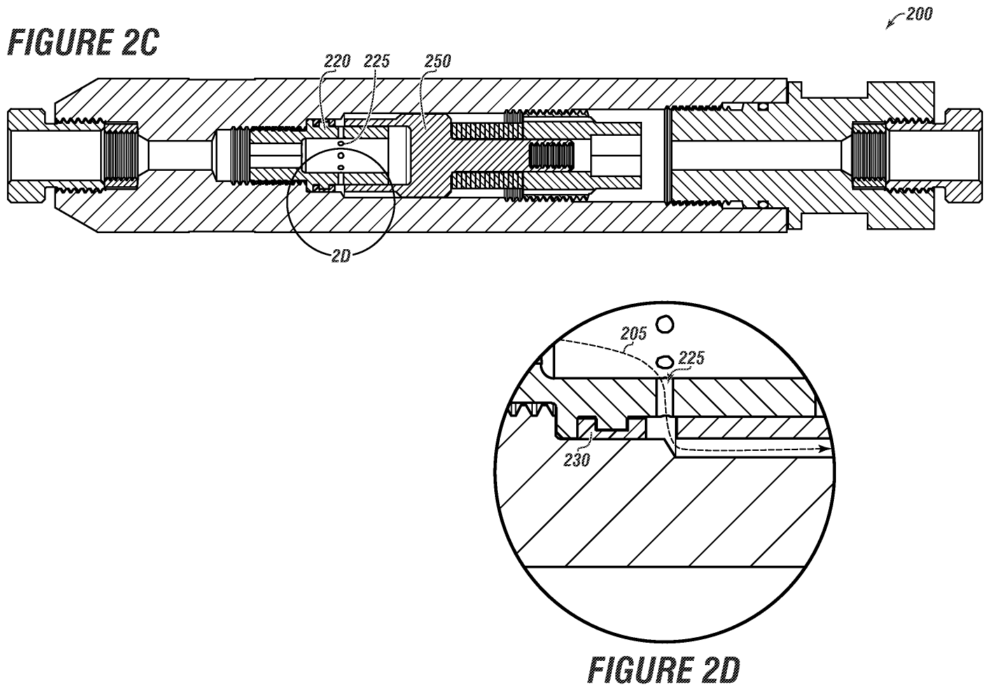

FIGS. 2A, 2B, 2C and 2D show an embodiment of the inline safety valve of the present disclosure.

The inline safety valve 200 can have a valve body 210. A poppet 220 can be disposed within the valve body 210 with a static seal 230 disposed between. A piston 250 can seal against poppet 220 and be biased to do so with bias 270, shown here as stacked Belleville washers. In embodiments, washers can be stacked upright, or inverted as desired to adjust the amount of bias. Any other spring or bias mechanism known to persons having ordinary skill in the art can be utilized. The bias can be adjusted with screw 275.

Note that the poppet 220 is stationary and that static seal 230 is not within the fluid flow path as distinguished from prior art. The poppet can have a plurality of holes 225 allowing fluid to flow therethrough.

The Fluid flow 205 through the plurality of holes 225 can cause the piston 250 to be displaced, thereby overcoming bias 270 and allowing fluid to flow through the inline safety valve 200.

In embodiments, an end cap 290 with a second static seal 295 can be utilized.

While the present disclosure emphasizes the presented embodiments and Figures, it should be understood that within the scope of the appended claims, the disclosure might be embodied other than as specifically enabled herein.

1. An inline safety valve comprising:
a a valve body;
b a poppet disposed within the valve body;
c a piston disposed within the valve body, wherein a portion of the piston is disposed between a portion of the poppet and the valve body;
d a plurality of holes disposed on the poppet allowing a fluid to flow therethrough;
e a bias on the piston, wherein the bias forces the piston toward the poppet, and further wherein the bias comprises a Belleville washer; and
f a static seal disposed between the poppet and the valve body, wherein the static seal is not within a flow path of the fluid.

2. The inline safety valve of claim 1, wherein the poppet is a bubble tight seal.

3. The inline safety valve of claim 1, wherein the bias on the piston is disposed between the piston and the valve body.

4. (canceled)

5. The inline safety valve of claim 1, wherein the bias on the piston is adjusted with a screw.

6. The inline safety valve of claim 1, wherein the static seal is a gasket or an o-ring.

7. The inline safety valve of claim 1, wherein the static seal holds the poppet stationary with respect to the valve body.

8. An inline safety valve comprising:
a a valve body;
b a poppet disposed within the valve body;
c a piston disposed within the valve body, wherein a portion of the piston is disposed between a portion of the poppet and the valve body;
d a plurality of holes disposed on the poppet allowing a fluid to flow therethrough;
e a bias on the piston, wherein the bias forces the piston toward the poppet, and further wherein the bias comprises a Belleville washer; and
f a static seal disposed between the poppet and the valve body; and
wherein fluid flow through the plurality of holes causes a displacement of the piston.

9. The inline safety valve of claim 8, wherein the poppet is a bubble tight seal.

10. The inline safety valve of claim 8, wherein the bias on the piston is disposed between the piston and the valve body.

11. (canceled)

12. The inline safety valve of claim 8, wherein the bias on the piston is adjusted with a screw.

13. The inline safety valve of claim 8, wherein the static seal is a gasket or an o-ring.

14. The inline safety valve of claim 8, wherein the static seal holds the poppet stationary with respect to the valve body.

15. The inline safety valve of claim 8, wherein an amount of the displacement of the piston determines the rate of fluid flow through the inline safety valve.
